(19) United States
(12) Patent Application Publication
(10) Pub. No.: US 2025/0065285 A1
(43) Pub. Date: Feb. 27, 2025

(54) BLENDER DELIVERY SYSTEM FOR USE WITH WATER BOTTLES

(71) Applicant: Nicholas Richard Domingo, Cameron, MO (US)

(72) Inventor: Nicholas Richard Domingo, Cameron, MO (US)

(21) Appl. No.: 18/811,598

(22) Filed: Aug. 21, 2024

Related U.S. Application Data
(60) Provisional application No. 63/533,746, filed on Aug. 21, 2023.

(51) Int. Cl. B01F 35/75; A47J 43/046; A47J 43/07; B01F 23/50; B01F 23/53; B01F 33/501; B01F 35/71; B01F 101/14; B67C 11/02

(52) U.S. Cl. CPC B01F 35/752; A47J 43/046; A47J 43/0716; B01F 23/53; B01F 23/56; B01F 33/5014; B01F 35/7173; B67C 11/02; B01F 2101/14

(57) ABSTRACT

The present invention relates to a blender delivery system designed for integration with water bottles. This system facilitates the efficient mixing of supplements, such as protein powders and other nutritional additives, directly into a water bottle without the need for separate blending containers. The delivery device incorporates threading at one end to securely attach to a blender base and an opening at the other end to form a watertight connection with a water bottle. The device's internal volume is designed to receive and mix supplement contents with liquid from the water bottle when connected to a blender base. This configuration allows for a seamless transfer of mixed contents back into the water bottle for easy consumption. This invention addresses the need for a convenient, portable, and mess-free solution to mixing dietary supplements in everyday settings.

### CROSS-REFERENCE TO RELATED APPLICATIONS

The present invention claims priority to provisional application Ser. No. 63/533,746, filed Aug. 21, 2023, which is incorporated herein at least by reference.

### BACKGROUND OF THE INVENTION

### 1. Field of the Invention

The present invention relates to a delivery system for mixing powder supplements, such as protein powder, creatine, BCAAs, pre-workout, etc., in water bottles without the need for a traditional blender or shaker bottle.

### 2. Description of Related Art

Traditional methods of mixing powder supplements in water bottles often require the use of a blender or shaker bottle. These methods can be cumbersome, messy, and inconvenient, especially for individuals who consume multiple supplements throughout the day. The present invention aims to address these challenges by providing a novel delivery system that allows for efficient mixing of powder supplements directly in water bottles.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present invention to provide a delivery device that is configured to attach seamlessly to both standard blender bases and water bottles to facilitate the transfer of contents to and from the blender base and water bottle.

In order to do so, the present invention comprises a cylindrical attachment delivery system that screws into an existing blender base and is designed to be pushed into the top of a water bottle. The system allows for the addition of various powder supplements into the water bottle, followed by mixing using the blender base. The invention provides a convenient and mess-free solution for mixing supplements in water bottles, enabling consumers to enjoy fully mixed supplements without the need for a separate blender bottle.

In one aspect of the invention, a delivery device configured to attach to a blender base and mate with a water bottle is provided, the delivery device comprising a cylindrical body having a first end, a second end, and an inner volume; the first end including threading configured to engage with corresponding threading on the blender base; the second end including an opening configured to form a connection with an opening of the water bottle; wherein the inner volume of the cylindrical body is configured to receive supplement contents and facilitate transfer of liquid contents from the water bottle into the inner volume for blending by the blender base, with the delivery device further configured to receive mixed contents from the blender base for delivery back into the water bottle for consumption.

In one embodiment, the second end further includes one or more seals around the opening to form a watertight connection with the water bottle. In one embodiment, the cylindrical body includes a tapered section towards the second end to facilitate the funneling of contents into the water bottle. In one embodiment, the cylindrical body is dimensioned to provide a seamless aesthetic and functional interface with the blender base when attached.

In another aspect of the invention, a method of using a delivery device in conjunction with a blender base and a water bottle is provided, comprising positioning the delivery device such that its second end mates with an opening of the water bottle; receiving contents within the delivery device's inner volume; attaching the delivery device to the blender base via a threading mechanism; rotating the assembly of the delivery device, blender base, and water bottle to facilitate transfer of the contents from the water bottle and the inner volume to the blender base via the delivery device; activating the blender base to mix the contents; transferring, via rotation, the mixed contents from the blender base back to the water bottle via the delivery device.

In one embodiment, the rotating step includes a 180-degree rotation of the delivery device, blender base, and water bottle assembly between an upright and an upside-down position to facilitate the transfer and blending of the contents. In another embodiment, a further step of securing a watertight seal between the second end of the delivery device and the opening of the water bottle using the seals integrated into the second end of the delivery device is provided.

In yet another embodiment, a delivery device configured to replace a lid on an existing blending chamber is provided, comprising a cylindrical body having a first end configured to threadingly engage with a blending chamber and a second end configured to mate with a water bottle; wherein the delivery device facilitates the direct transfer of blended contents into the water bottle.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective front view of a delivery device installed on a blender base positioned next to a water bottle according to an embodiment of the present invention.

FIG. 2 is a perspective front view of the delivery device removed from the blender base according to an embodiment of the present invention.

FIG. 3 illustrates a user adding supplements to the internal volume of the delivery device for use, wherein the delivery device is flipped upside down and positioned on top of a water bottle.

FIG. 4 is the delivery device attached to the blender base and flipped right side up such that the contents of the water bottle and supplements enter the internal volume of the delivery device.

FIG. 5 is the delivery device attached to the blender base and flipped upside down and positioned on top of a water bottle such that the blended contents are delivered to the water bottle.

FIG. 6 is a perspective front view of a first alternative delivery device according to an embodiment of the present invention.

FIG. 7 is a perspective front view of a second alternative delivery device according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a blender delivery system for use with water bottles.

It is to be understood that the terminology used herein is for the purpose of describing particular embodiments only and is not intended to be limiting. The terms “a” or “an” are defined to mean “at least one.” The term “plurality” is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

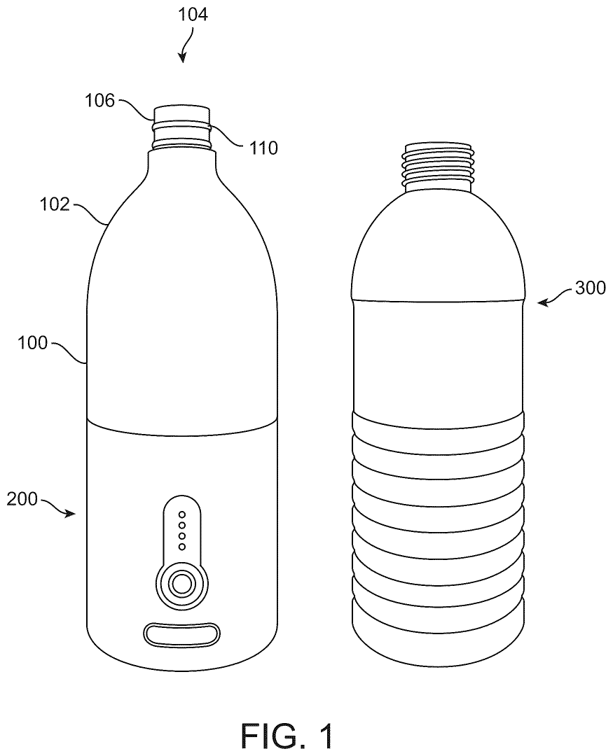

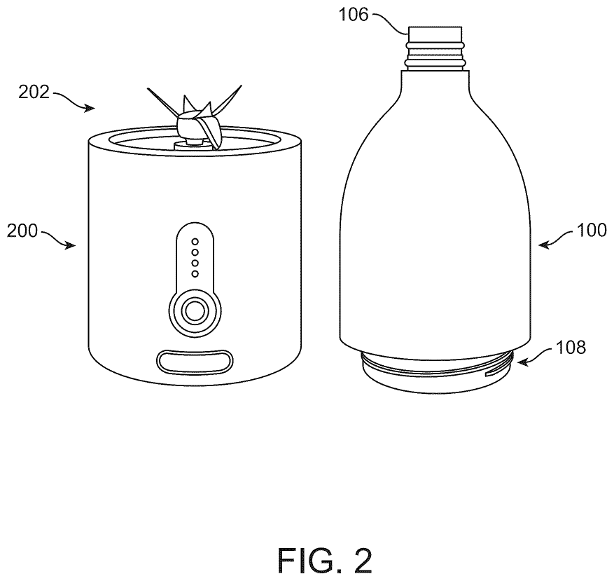

Referring now to FIGS. 1-2, the blender delivery system comprising a delivery device 100 for use with water bottles 300. In one embodiment, the delivery device 100 includes a cylindrical body having a first end 108 and a second end 106. The cylindrical body's first end 108 is configured to be attached to a blender base 200 via a threading method, as well known in the art. The second end 106 includes an opening 104 for mating with the mouth or opening of a water bottle 300. In some embodiments, the second end includes a number of seals 110 or O-rings around the opening 104 to form a watertight fit on the mouth or opening of the water bottle, which will be discussed in greater detail below. In one embodiment, the cylindrical body 100 tapers 102 towards the second end, providing a funnel for adding and delivering substances/supplements or other for mixing.

Advantageously, the second end of the delivery device is specifically designed and configured to form a secure and efficient connection with the top of a standard water bottle. This end includes an opening that can be secured to the water bottle using a press-fit mechanism, which is complemented by a series of strategically positioned seals or O-rings as previously described. These seals are critical in preventing any leakage during the mixing and transfer processes, ensuring a reliable and mess-free operation. Additionally, alternative embodiments of the device may employ a threaded connection to enhance compatibility and security, or utilize other connection mechanisms such as a clamp, snap-fit, or magnetic attachment to accommodate varying user preferences and water bottle designs. The range of connection options allows the delivery device to be universally compatible with a wide range of water bottle types, making it an ideal solution for users with varying preferences in water bottle brands and sizes.

Advantageously, the delivery device 100 and specifically the cylindrical body's first end is sized and shaped to conform and attach to the blender base 200. In some embodiments, the blender base is a personal sized blender, however the size may vary without departing from the spirit and scope of the invention. The blender base 200 includes a mixing/blending blade 202 configured to blend and/or mix substances at a variety of speeds as well known in the art.

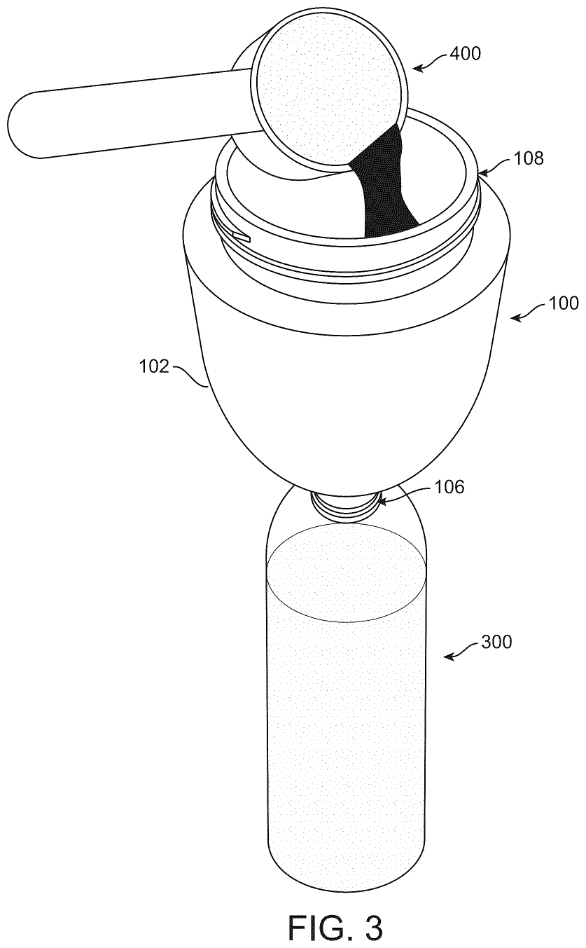

FIG. 3 illustrates a user adding supplements 400 to the internal volume of the delivery device 100 for use, wherein the delivery device is flipped upside down and positioned on top of the water bottle 300. This is the first step when using the blender system. Advantageously, the tapered shape 102 facilitates the collection and direction of the supplements 400 towards the second end 106 of the device. The water bottle 300 may be filled with any desired liquid the user intends to mix the supplements with, such as water, milk, juice, coconut water, and coffee. In this arrangement, the water bottle 300 upright, and the delivery device 100 is connected to the water bottle via the second end 104 of the delivery device at the mouth or opening of the water bottle 300. In some embodiments, the supplement substance 400 is a dry supplement powder, such as protein powder, creatine, essential amino acids, a pre-workout mix, vitamins, etc. In some embodiments, the supplements 400 may include fruit, vegetables, or other raw ingredients.

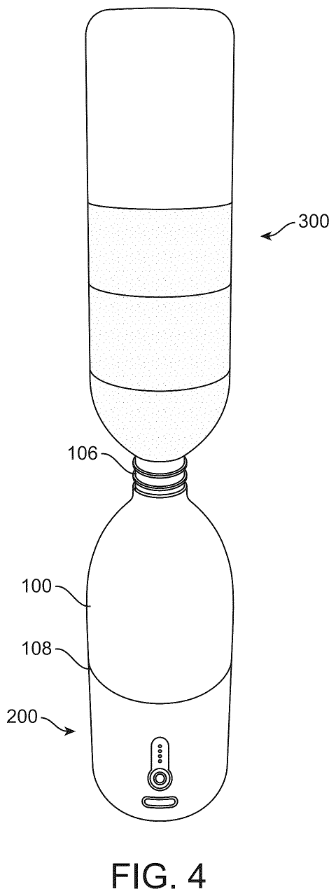

Referring now to FIG. 4, next, the blender base 200 is mated and connected with the first end 108 of the delivery device, such as a threaded connection as previously discussed. Then the delivery system is flipped upright as illustrated, wherein the blender base 200 is positioned on a supporting surface, such as a counter. In this arrangement, the delivery device 100 is positioned above the blender base, and the water bottle 300 is flipped such that the contents within the bottle (liquid/water and supplements) are at least partially transferred to the delivery device volume. Next, the blender base is turned on to blend/mix the substance and liquid.

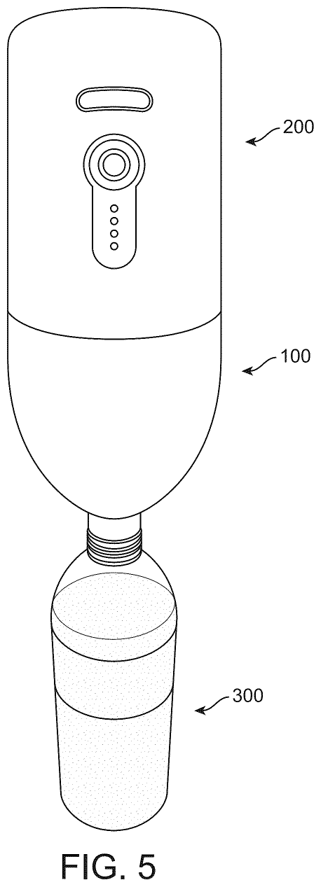

Referring now to FIG. 5, after blending, the delivery system is flipped again, transferring all the blended/mixed contents from the delivery device into the water bottle. Next, the delivery device and blender are removed leaving only the water bottle with the blended/mixed contents ready for consumption.

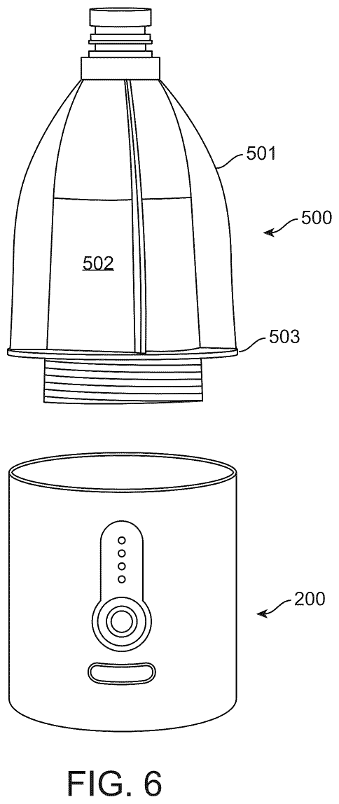

FIG. 6 is a perspective front view of a first alternative delivery device according to an embodiment of the present invention. Referring now to FIG. 6, a typical blender base 200 is shown with an alternative delivery device 500. Conceptually, the delivery device is as previously described, however in this embodiment, the delivery device 500 comprises fins 501 positioned around the cylindrical volume 502. The fins may be different shapes and sizes, but the fins are configured to match the diameter of the blender base at the lower end or flange 503 allowing the blender base and delivery device to have a seamless appearance when connected. In some embodiments, the fins aid in the removal and installation of the delivery device on the blender base. The first alternative delivery device is easier to manufacture compared to the previous embodiment, which is intended to be constructed via blow molding. Operation of this embodiment is identical to the operation as previously described.

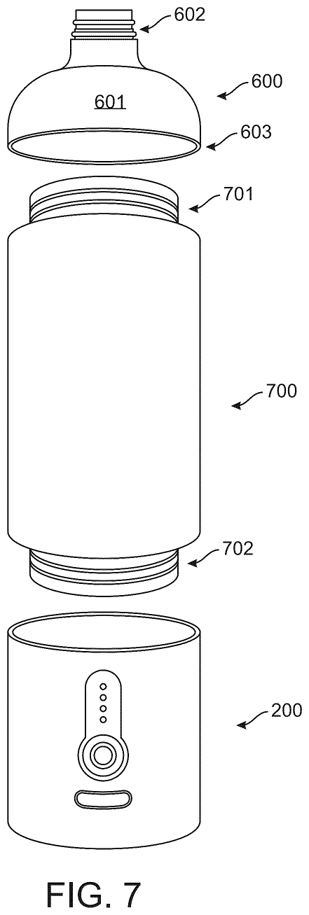

FIG. 7 is a perspective front view of a second alternative delivery device according to an embodiment of the present invention. Referring now to FIG. 7, the second alternative delivery device 600 is illustrated. In this embodiment, a delivery system is provided to accommodate using an existing blending chamber/container 700, wherein the delivery device replaces the lid of the existing blending system to create a delivery system in a similar manner as previously described. More specifically, the second alternative delivery device 600 includes a tapered body 601 having a first end 603 and a second end 602. The second end is configured to mate and connect with a water bottle (not illustrated) in a manner as similarly described, wherein the second end includes seals to provide a liquid tight seal with the water bottle. The first end 603 is threaded and configured to mate with a first end 701 of the existing blending chamber 700. This is normally where a lid would be affixed to. The second end 702 of the existing blending chamber 700 would mate with the blender base 200 for use. In this embodiment, the user would blend their supplements and liquid within the blending chamber and use the delivery device to connect and pour the blended contents within the water bottle for consumption.

The delivery device may be constructed from a variety of materials chosen for their durability, safety, and compatibility with food products. Non-limiting examples include plastics such as polyethylene, polypropylene, or polycarbonate, as well as metals, including but not limited to stainless steel and aluminum. Additionally, environmentally friendly materials such as biodegradable plastics or recycled materials may be provided.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention. For example, although water bottles are described, it should be apparent that other bottles may be utilized with the delivery device, such as reusable or insulated bottles, bottles of various shapes and sizes, and any type of liquid receptacle.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and so forth members throughout the disclosure (and in particular, claims) are not used to show a serial or numerical limitation but instead are used to distinguish or identify the various members of the group.

### REFERENCE NUMBER LIST

100—Delivery device
102—Tapered body/volume of the delivery device
104—Opening at the second end of the delivery device
106—Second end of the delivery device
108—First end of the delivery device
110—Seals on the second end of the delivery device
200—Blender base
202—Mixing/blending blade of the blender base
300—Water bottle
400—Supplement contents
500—First alternative delivery device
501—Fins on the first alternative delivery device
502—Cylindrical body/volume of the first alternative delivery device
503—Lower end or flange of the first alternative delivery device
600—Second alternative delivery device
601—Tapered body/volume of the second alternative delivery device
602—Second end of the second alternative delivery device
603—First end of the second alternative delivery device
700—Existing blending chamber
701—First end of the existing blending chamber
702—Second end of the existing blending chamber

What is claimed is:

1. A delivery device configured to attach to a blender base and mate with a water bottle, the delivery device comprising:
a cylindrical body having a first end, a second end, and an inner volume;
the first end including threading configured to engage with corresponding threading on the blender base;
the second end including an opening configured to form a connection with an opening of the water bottle;
wherein the inner volume of the cylindrical body is configured to receive supplement contents and facilitate transfer of liquid contents from the water bottle into the inner volume for blending by the blender base, with the delivery device further configured to receive mixed contents from the blender base for delivery back into the water bottle for consumption.

2. The delivery device of claim 1, wherein the second end further includes one or more seals around the opening to form a watertight connection with the water bottle.

3. The delivery device of claim 1, wherein the cylindrical body includes a tapered section towards the second end to facilitate the funneling of contents into the water bottle.

4. The delivery device of claim 1, wherein the cylindrical body is dimensioned to provide a seamless aesthetic and functional interface with the blender base when attached.

5. A method of using a delivery device in conjunction with a blender base and a water bottle, comprising:
positioning the delivery device such that its second end mates with an opening of the water bottle;
receiving contents within the delivery device's inner volume;
attaching the delivery device to the blender base via a threading mechanism;
rotating the assembly of the delivery device, blender base, and water bottle to facilitate transfer of the contents from the water bottle and the inner volume to the blender base via the delivery device;
activating the blender base to mix the contents;
transferring, via rotation, the mixed contents from the blender base back to the water bottle via the delivery device.

6. The method of claim 5, wherein the rotating step includes a 180-degree rotation of the delivery device, blender base, and water bottle assembly between an upright and an upside-down position to facilitate the transfer and blending of the contents.

7. The method of claim 5, further comprising securing a watertight seal between the second end of the delivery device and the opening of the water bottle using the seals integrated into the second end of the delivery device.

8. A delivery device configured to replace a lid on an existing blending chamber, comprising:
a cylindrical body having a first end configured to threadingly engage with a blending chamber and a second end configured to mate with a water bottle;
wherein the delivery device facilitates the direct transfer of blended contents into the water bottle.

9. The delivery device of claim 8, wherein the cylindrical body includes a tapered configuration at the second end to direct blended contents into the water bottle efficiently.
